(19) United States
(12) Patent Application Publication
(10) Pub. No.: US 2021/0326538 A1
(43) Pub. Date: Oct. 21, 2021

(54) METHOD, APPARATUS, ELECTRONIC DEVICE FOR TEXT TRANSLATION AND STORAGE MEDIUM

(71) Applicant: BEIJING BAIDU NETCOM SCIENCE AND TECHNOLOGY CO., LTD., Beijing (CN)

(72) Inventors: Chuanqiang ZHANG, Beijing (CN); Ruiqing ZHANG, Beijing (CN); Zhi LI, Beijing (CN); Zhongjun HE, Beijing (CN); Hua WU, Beijing (CN)

(73) Assignee: BEIJING BAIDU NETCOM SCIENCE AND TECHNOLOGY CO., LTD.

(21) Appl. No.: 17/362,628

(22) Filed: Jun. 29, 2021

(30) Foreign Application Priority Data
Dec. 25, 2020 (CN) 202011556253.9

(51) Int. Cl. G06F 40/58; G06F 40/30

(52) U.S. Cl. CPC G06F 40/58; G06F 40/30

(57) ABSTRACT

A method for text translation includes obtaining a text to be translated; and inputting the text to be translated into a text translation model. The trained text translation model divides the text to be translated into a plurality of semantic units, determines N semantic units before a current semantic unit among the plurality of semantic units as local context semantic units, determines M semantic units before the local context semantic units as global context semantic units, and generates a translation result of the current semantic unit based on the local context semantic units and the global context semantic units. N is an integer, and M is an integer.

### CROSS-REFERENCE TO RELATED APPLICATION

This application claims priority to Chinese Patent Application No. 202011556253.9, filed on Dec. 25, 2020, the content of which is incorporated herein by reference in its entirety.

### TECHNICAL FIELD

The present disclosure relates to the technical fields of voice processing, natural language processing, and deep learning, and particularly to a method for text translation, an apparatus for text translation, an electronic device, a storage medium and a computer program product.

### BACKGROUND

At present, with the development of the artificial intelligence, natural language processing and other technologies, voice translation technology has been widely used in scenarios such as simultaneous interpreting and foreign language teaching. For example, in a simultaneous interpreting scenario, the voice translation technology can synchronously convert the speaker's language type to a different language type, making it easier for people to communicate. However, the problems such as incoherent translation, inconsistent translation of the context and the like may occur in the translation result from voice translation methods in the related art.

### SUMMARY

According to a first aspect, a method for text translation includes: obtaining a text to be translated; and inputting the text to be translated into a trained text translation model. The trained text translation model divides the text to be translated into a plurality of semantic units, determines N semantic units before a current semantic unit among the plurality of semantic units as local context semantic units, determines M semantic units before the local context semantic units as global context semantic units, and generates a translation result of the current semantic unit based on the local context semantic units and the global context semantic units. N is an integer, and M is an integer.

According to a second aspect, an apparatus for text translation includes at least a processor and a memory. The memory may be communicatively coupled to the at least one processor and stored with instructions executable by the at least one processor. The at least one processor may be configured to obtain a text to be translated; and input the text to be translated into a trained text translation model. The trained text translation model divides the text to be translated into a plurality of semantic units, determines N semantic units before a current semantic unit among the plurality of semantic units as local context semantic units, determines M semantic units before the local context semantic units as global context semantic units, and generates a translation result of the current semantic unit based on the local context semantic units and the global context semantic units. N is an integer, and M is an integer.

According to a third aspect, there is provided a non-transitory computer-readable storage medium having computer instructions stored thereon, wherein the computer instructions are configured to cause a computer to implement the method for text translation in the first aspect of the present disclosure.

It should be understood that the content in this part is not intended to identify key or important features of the embodiments of the present disclosure, and does not limit the scope of the present disclosure. Other features of the present disclosure will be easily understood through the following specification.

### BRIEF DESCRIPTION OF THE DRAWINGS

The drawings herein are used to better understand the solution, and do not constitute a limitation to the disclosure.

FIG. 1 is a flow chart illustrating a method for text translation according to a first embodiment of the present disclosure;

FIG. 2 is a flow chart illustrating the action of generating a translation result of a current semantic unit in a method for text translation according to a second embodiment of the present disclosure;

FIG. 3 is a flow chart illustrating the action of generating a vector representation of a current semantic unit in a method for text translation according to a third embodiment of the present disclosure;

FIG. 4 is a flow chart illustrating the action of generating a global fusion vector representation of a word segmentation in a method for text translation according to a fourth embodiment of the present disclosure;

FIG. 5 is a block diagram illustrating an apparatus for text translation according to a first embodiment of the present disclosure;

FIG. 6 is a block diagram illustrating an apparatus for text translation according to a second embodiment of the present disclosure;

FIG. 7 is a block diagram illustrating an electronic device to implement a method for text translation of the embodiments of the present disclosure.

### DETAILED DESCRIPTION

The following describes exemplary embodiments of the present disclosure with reference to the accompanying drawings, which include various details of the embodiments of the present disclosure to facilitate understanding, and they should be considered as merely exemplary. Therefore, those skilled in the art should realize that various changes and modifications may be made to the embodiments described herein without departing from the scope and spirit of the present disclosure. Similarly, for clarity and conciseness, descriptions of well-known functions and structures are omitted in the following description.

The voice may include technical fields such as voice recognition, voice interaction and the like, which is an important direction in the field of artificial intelligence.

The voice recognition is a technology that allows machines to convert voice signals to corresponding texts or commands through the recognition and understanding process. It mainly includes three aspects: a feature extraction technology, a pattern matching criteria and a model training technology.

The voice interaction is a technology in which interaction behaviors (such as interaction, communication, and information exchange) are performed between machines and users through the voices as an information carrier. Compared with traditional human-machine interaction, the voice interaction has the advantages such as convenience and efficiency, and high user comfort.

The natural language processing (NLU) is a science that studies computer systems, especially software systems, which can effectively realize natural language communication. It is an important direction in the fields of computer science and artificial intelligence.

The deep learning (DL) is a new research direction in the field of machine learning (ML). It is a science that learns inherent laws and representation levels of sample data so as to make machines analyze and learn like humans, and recognize data such as words, images and sounds, which is widely used in the voice and image recognition.

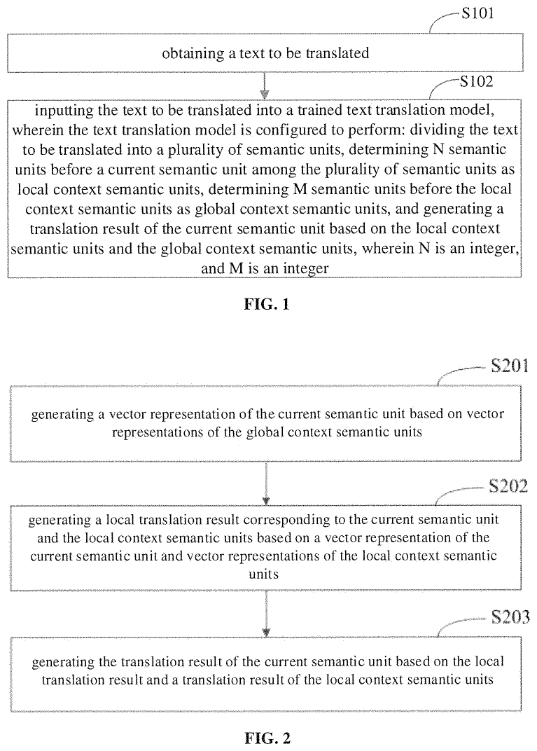

FIG. 1 is a flow chart illustrating a method for text translation according to a first embodiment of the present disclosure.

As illustrated in FIG. 1, the method for text translation according to a first embodiment of the present disclosure includes the following blocks.

In block S101, a text to be translated is obtained.

It should be noted that the executive subject of the method for text translation in the embodiments of the present disclosure may be hardware devices with data information processing ability and/or software required to drive the hardware device. Optionally, the executive subject may include work stations, servers, computers, user terminals and other devices. The user terminals include, but are not limited to, mobile phones, computers, intelligent voice interaction devices, intelligent household appliances, on-board terminals and the like.

In the embodiments of the present disclosure, the text to be translated may be obtained. It should be understood that the text to be translated may be composed of a plurality of sentences.

Optionally, the text to be translated may be obtained by recording, network transmission and the like.

For example, when the text to be translated is obtained by recording, a voice collection apparatus is provided on the device, which may be a microphone, a microphone array and the like. When the text to be translated is obtained by the network transmission, a networking device is provided on the device, which may be used for network transmission with other devices or servers.

It should be understood that the text to be translated may be in forms of audios, texts and the like, which is not limited here.

It should be noted that, in the embodiments of the present disclosure, neither the language type of the text to be translated nor the language type of the translation result are limited.

In block S102, the text to be translated is input into a trained text translation model. The text translation model divides the text to be translated into a plurality of semantic units. N semantic units before a current semantic unit are determined as local context semantic units. M semantic units before the local context semantic units are determined as global context semantic units. A translation result of the current semantic unit is generated based on the local context semantic units and the global context semantic units. N is an integer, and M is an integer.

In the related art, the translation model is trained mostly based on sentence-level bilingual sentence pairs, and the translation results of the translation model are not flexible enough. For example, in a text translation scenario, the text to be translated is composed of a plurality of sentences. At this time, the translation results of the translation model will have problems such as the incoherent translation and inconsistent translation of the context. For example, when the text translation scenario is an animation rendering keynote speech, and the text to be translated is “It starts with modeling”, the translation result of the translation model at this time is “ [symbol] (It starts with molding)”, but at this time the word “modeling” in the text to be translated means “ [symbol] (modeling)” in the context, rather than “ [symbol] (molding)”, and the translation result “ [symbol] [symbol] (It starts with modeling)” is more conform to the speaker's real intention.

In order to solve this problem, in the present disclosure, the text to be translated may be input into a trained text translation model, in which the text translation model divides the text to be translated into a plurality of semantic units, N semantic units before a current semantic unit are determined as local context semantic units, M semantic units before the local context semantic units are determined as global context semantic units, and a translation result of the current semantic unit is generated based on the local context semantic units and the global context semantic units, in which N is an integer, and M is an integer.

It should be understood that the text translation model can divide the text to be translated into the plurality of semantic units, and generate the translation result of the current semantic unit based on the local context semantic units and the global context semantic units, which may solve the problem of incoherent translation and inconsistent translation of the context in the related art, and may be suitable for text translation scenarios, such as the simultaneous interpretation scenario.

Optionally, N and M may be set according to actual situations.

In an embodiment of the present disclosure, there are a total of (N+M) semantic units before the current semantic unit. The local context semantic units and the global context semantic units determined at this time constitute all the semantic units before the current semantic unit. All the semantic units before the current semantic unit may be used to generate the translation result of the current semantic unit.

In an embodiment of the present disclosure, when the current semantic unit is the first semantic unit of the text to be translated, that is, there are no other semantic units before the current semantic unit, N=0 and M=0.

For example, when the text to be translated is “ [symbol] , [symbol] , [symbol] , [symbol] [symbol] [symbol] (the subsequent sentences are omitted here)”, then the above text to be translated may be divided into a plurality of semantic units as follows: “ [symbol] (Hello, everybody)”, “ [symbol] (I am Zhang SAN)”, “ [symbol] (is a)”, “ [symbol] (Chinese teacher)”, “ [symbol] (today)”, “ [symbol] (introduction)”, “ [symbol] (mainly divided to)”, “ [symbol] (three parts)”, and the like. In order to better understand the concrete examples in the disclosure, the semantic units in Chinese herein are translated to the corresponding words in English and shown in the brackets, and these translated words in the brackets do not constitute limitations to the whole embodiment of the disclosure.

When the current semantic unit is “ [symbol] ”, the two semantic units before the current semantic unit “ [symbol] ” may be determined as local context semantic units. That is, “ [symbol] ” and “ [symbol] ” may be determined as local context semantic units. The four semantic units before the local context semantic units can also be determined as the global context semantic units. That is, “ [symbol] ”, “ [symbol] ”, “ [symbol] ” and “ [symbol] ” are determined as the global context semantic units. According to the local context semantic units and the global context semantic units determined above, the translation result of the current semantic unit “ [symbol] ” is generated. In the embodiment, N is 2 and M is 4.

When the current semantic unit is “ [symbol] ” which is the first semantic unit of the text to be translated, there is no local context semantic unit and global context semantic unit at this time, that is, N=0 and M=0.

In summary, according to the method for text translation in the embodiments of the present disclosure, the text to be translated may be input in the trained text translation model, the translation result of the current semantic unit may be generated based on the local context semantic units and the global context semantic units, which can solve the problem of incoherent translation and inconsistent translation of the context in the related art, improve the accuracy of the translation result, and be suitable for text translation scenario.

On the basis of any one of the above embodiments, as illustrated in FIG. 2, generating a translation result of the current semantic unit based on the local context semantic units and the global context semantic units in block S102 may include the following blocks.

In block S201, a vector representation of the current semantic unit is generated based on vector representations of the global context semantic units.

In the embodiments of the present disclosure, each semantic unit may correspond to a vector representation.

It should be understood that the vector representations of the global context semantic units may be obtained first. The vector representations of the global context semantic units include vector representations of the M semantic units before the local context semantic units, and then the vector representation of the current semantic unit is generated based on the vector representations of the global context semantic units.

In block S202, a local translation result corresponding to the current semantic unit and the local context semantic units is generated based on the vector representation of the current semantic unit and vector representations of the local context semantic units.

It should be understood that the vector representations of the local context semantic units may be obtained first. The vector representations of the local context semantic units includes vector representations of the N semantic units before the current semantic unit, and then the local translation result corresponding to the current semantic unit and the local context semantic units is generated based on the vector representation of the current semantic unit and the vector representations of the local context semantic units.

For example, when the current semantic unit is “ [symbol] ” and the local semantic units include “ [symbol] ” and “ [symbol] ”, the corresponding local translation result is “Today's introduction is mainly divided into”.

In block S203, a translation result of the current semantic unit is generated based on the local translation result and a translation result of the local context semantic units.

In the embodiments of the present disclosure, generating the translation result of the current semantic unit based on the local translation result and the translation result of the local context semantic units may include obtaining the translation result of the local context semantic units, and removing the translation result of the local context semantic units from the local translation result to obtain the translation result of the current semantic unit.

It should be understood that the local translation result corresponding to the current semantic unit and the local context semantic units is composed of the translation result of the current semantic unit and the translation result of the local context semantic units.

For example, when the current semantic unit is “ [symbol] ” and the local semantic units include “ [symbol] ” and “ [symbol] ”, the corresponding local translation result is “Today's introduction is mainly divided into”, and the translation result of the local semantic units “ [symbol] ” and “ [symbol] ” is “Today's introduction”. “Today's introduction” may be removed from the above local translation result “Today's introduction is mainly divided into”. Then the translation result “is mainly divided into” of the current semantic unit “ [symbol] ” may be obtained.

Therefore, in the method, the vector representation of the current semantic unit may be generated based on the vector representations of the global context semantic units, the local translation result corresponding to the current semantic unit and the local context semantic units may be generated based on the vector representation of the current semantic unit and the vector representations of the local context semantic units, and the translation result of the current semantic unit may be generated based on the local translation result and the translation result of the local context semantic units.

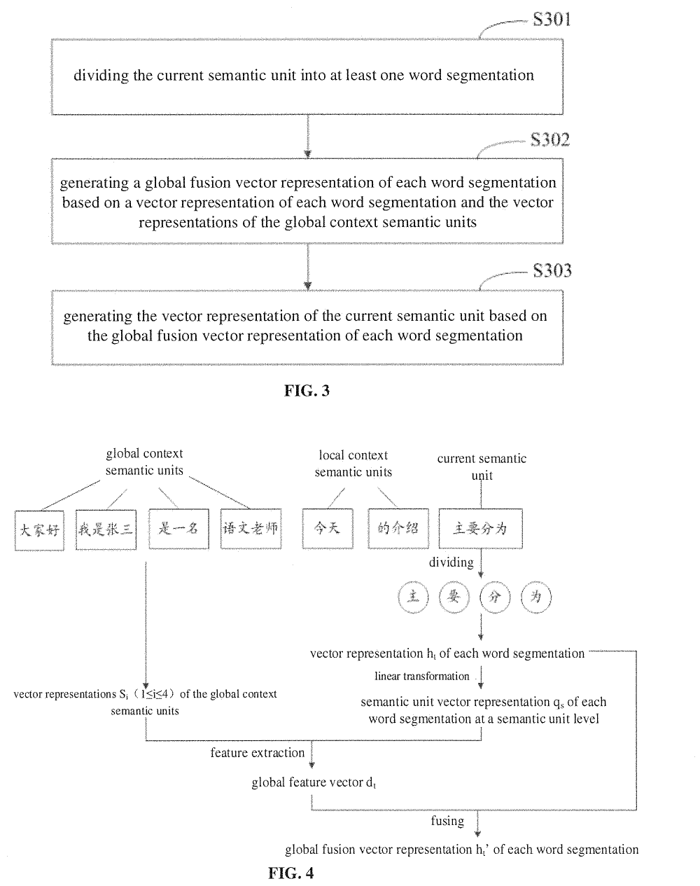

On the basis of any one of the above embodiments, as illustrated in FIG. 3, generating a vector representation of the current semantic unit based on vector representations of the global context semantic units in block S201 includes the following blocks.

In block S301, the current semantic unit is divided into at least one word segmentation.

It should be understood that each semantic unit may include at least one word segmentation, and then the current semantic unit may be divided into the at least one word segmentation.

Optionally, the current semantic unit may be divided into at least one word segmentation based on a preset word segmentation unit. The word segmentation unit includes, but is not limited to, a character, a word, words and expressions, and the like.

For example, when the current semantic unit is “ [symbol] ” and the word segmentation unit is a character, the current semantic unit may be divided into four word segmentations: “ [symbol] ”, “ [symbol] ”, “ [symbol] ”, and “ [symbol] ”.

In block S302, a global fusion vector representation of each word segmentation is generated based on the vector representation of each word segmentation and the vector representations of the global context semantic units.

It should be understood that each word segmentation corresponds to a vector representation, and the global fusion vector representation of each word segmentation may be generated based on the vector representation of each word segmentation and the vector representations of the global context semantic units.

Optionally, generating the global fusion vector representation of each word segmentation based on the vector representation of each word segmentation and the vector representations of the global context semantic units may include performing linear transformation on the vector representation of each word segmentation to generate a semantic unit vector representation of each word segmentation at a semantic unit level; performing feature extraction on the vector representations of the global context semantic units based on the semantic unit vector representation of each word segmentation to generate a global feature vector; and fusing the global feature vector and the vector representation of each word segmentation to generate the global fusion vector representation of each word segmentation.

Optionally, the above process of generating the global fusion vector representation of each word segmentation may be implemented by the following formula:

qₛ=fₛ(hₜ)

dₜ=MutiHeadAttention (qₛ,Sᵢ) (1≤i≤M)

λₜ=σ(Whₜ+Udₜ)

hₜ′=λₜhₜ+(1−λₜ)dₜ

where hₜ is a vector representation of a word segmentation, fₛ (⋅) is a linear transformation function, qₛ is a semantic unit vector representation of the word segmentation, MutiHeadAttention (⋅) is an attention function, dₜ is a global feature vector, and hₜ′ is a global fusion vector representation of the word segmentation.

where Sᵢ (1≤i≤M) are vector representations of the global context semantic units, in which S1 is a vector representation of the first semantic unit in the global context semantic units, and S2 is a vector representation of the second semantic unit in the global context semantic units, and so on. Therefore, S_{M} is a vector representation of the M-th semantic unit in the global context semantic units.

where W, U, and σ are all coefficients, which may be set according to actual situations.

For example, as illustrated in FIG. 4, when the current semantic unit is “ [symbol] ”, the local context semantic units are “ [symbol] ” and “ [symbol] ”, and the global context semantic units are “ [symbol] , [symbol] ”, “ [symbol] ”, “ [symbol] ”, and “ [symbol] ”. The current semantic unit “ [symbol] ” may be divided into four word segmentations, “ [symbol] ”, “ [symbol] ”, “ [symbol] ”, and “ [symbol] ”. Linear transformation may be performed on the vector representation hₜ of any one of the word segmentations to generate the semantic unit vector representation qₛ of the word segmentation at the semantic unit level, feature extraction may be performed on the vector representations Sᵢ (1≤i≤4) of the global context semantic units based on the semantic unit vector representation qₛ of the word segmentation to generate the global feature vector dₜ, and the global feature vector dₜ and the vector representation hₜ of the word segmentation are fused to generate the global fusion vector representation hₜ′ of the word segmentation. It should be noted that, in this embodiment, S₁ is the vector representation corresponding to the semantic unit “ [symbol] ”, S₂ is the vector representation corresponding to the semantic unit “ [symbol] ”, S₃ is the vector representation corresponding to the semantic unit “ [symbol] ”, [symbol] ”, and S4 is the vector representation corresponding to the semantic unit “

[symbol]

It should be understood that in this method, feature extraction may be performed on the vector representations of the global context semantic units to generate a global feature vector, and the global feature vector and the vector representation of the word segmentation may be fused to generate the global fusion vector representation of the word segmentation. The global fusion vector representation may learn features from the vector representations of the global context semantic units.

In block S303, the vector representation of the current semantic unit is generated based on the vector representations of the global context semantic units.

It should be understood that the current semantic unit may be divided into at least one word segmentation, and each word segmentation has a global fusion vector representation. The vector representation of the current semantic unit may be generated based on the global fusion vector representations of all word segmentations divided by the current semantic unit.

Optionally, generating the vector representation of the current semantic unit based on the global fusion vector representation of the word segmentation may include determining a weight corresponding to the global fusion vector representation of each word segmentation; and obtaining the vector representation of the current semantic unit by calculating the global fusion vector representation of the word segmentation and the corresponding weight. The vector representation of the current semantic unit may be obtained in a weighted average manner.

Thus, in the method, the current semantic unit may be divided into at least one word segmentation, the global fusion vector representation of each word segmentation may be generated based on the vector representation of each word segmentation and the vector representations of the global context semantic units, and the vector representation of the current semantic unit may be generated based on the global fusion vector representation of each word segmentation.

On the basis of any one of the above embodiments, obtaining the trained text translation model in block S102 may include obtaining a sample text and a sample translation result corresponding to the sample text; and training a text translation model to be trained based on the sample text and the sample translation result to obtain the trained text translation model.

It should be understood that in order to improve the performance of the text translation model, a large number of sample texts and sample translation results corresponding to the sample texts are obtained.

In the specific implementation, the sample text may be input into the text translation model to be trained to obtain a first sample translation result output by the text translation model to be trained. There may be a larger error between the first sample translation result and the sample translation result. According to the error between the first sample translation result and the sample translation result, the text translation model to be trained may be trained until the text translation model to be trained converges, or a number of iterations reaches a preset threshold of the number of iterations, or the accuracy of the model reaches a preset accuracy threshold, so that the training of the model may be ended, and the text translation model obtained after the last training is considered as the trained text translation model. The threshold of the number of iterations and the threshold of accuracy may be set according to actual situations.

Therefore, the text translation model to be trained in the method may be trained based on the sample text and the sample translation result to obtain the trained text translation model.

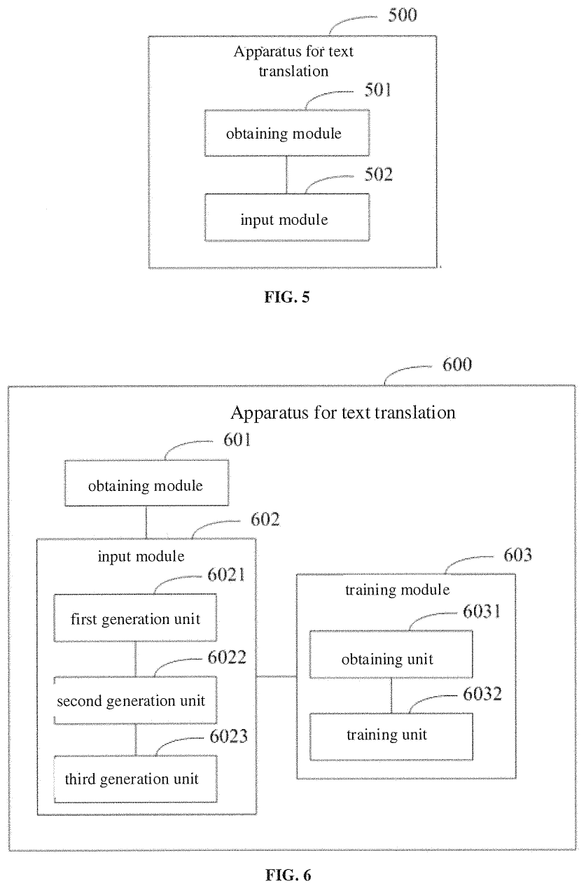

FIG. 5 is a block diagram illustrating an apparatus for text translation according to a first embodiment of the present disclosure.

As illustrated in FIG. 5, the apparatus 500 for text translation according to the embodiments of the present disclosure includes: an obtaining module 501 and an input module 502. The obtaining module 501 is configured to obtain a text to be translated. The input module 502 is configured to input the text to be translated into a trained text translation model, in which the text translation model divides the text to be translated into a plurality of semantic units, determine N semantic units before a current semantic unit as local context semantic units, determine M semantic units before the local context semantic units as global context semantic units, and generate a translation result of the current semantic unit based on the local context semantic units and the global context semantic units, in which N is an integer, and M is an integer.

In summary, according to the apparatus for text translation in the embodiments of the present disclosure, the text to be translated may be input in the trained text translation model, a translation result of the current semantic unit may be generated based on the local context semantic units and the global context semantic units, which can solve the problem of incoherent translation and inconsistent translation of the context in the related art, improve the accuracy of the translation result, and be suitable for text translation scenario.

FIG. 6 is a block diagram illustrating an apparatus for text translation according to a second embodiment of the present disclosure.

As illustrated in FIG. 6, the apparatus 600 for text translation of the embodiments of the present disclosure includes: an obtaining module 601, an input module 602 and a training module 603. The obtaining module 601 has the same function and structure as the obtaining module 501.

In an embodiment of the present disclosure, the input module 602 includes: a first generation unit 6021, configured to generate a vector representation of the current semantic unit based on vector representations of the global context semantic units; a second generation unit 6022, configured to generate a local translation result corresponding to the current semantic unit and the local context semantic units based on the vector representation of the current semantic unit and vector representations of the local context semantic units; and a third generation unit 6023, configured to generate the translation result of the current semantic unit based on the local translation result and a translation result of the local context semantic units.

In an embodiment of the present disclosure, the first generation unit 6021 includes: a division sub-unit, configured to divide the current semantic unit into at least one word segmentation; a first generation sub-unit, configured to generate a global fusion vector representation of each word segmentation based on a vector representation of each word segmentation and the vector representations of the global context semantic units; and a second generation sub-unit, configured to generate the vector representation of the current semantic unit based on the global fusion vector representation of each word segmentation.

In an embodiment of the present disclosure, the first generation sub-unit is specifically configured to: perform linear transformation on the vector representation of each word segmentation to generate a semantic unit vector representation of each word segmentation at a semantic unit level; perform feature extraction on the vector representations of the global context semantic units based on the semantic unit vector representation of each word segmentation to generate a global feature vector; and fuse the global feature vector and the vector representation of each word segmentation to generate the global fusion vector representation of each word segmentation.

In an embodiment of the present disclosure, the second generation sub-unit is specifically configured to: determine a weight corresponding to the global fusion vector representation of each word segmentation; and obtain the vector representation of the current semantic unit by calculating the global fusion vector representation of each word segmentation and the weight.

In an embodiment of the present disclosure, the training module 603 includes: an obtaining unit 6031, configured to obtain a sample text and a sample translation result corresponding to the sample text; and a training unit 6032, configured to train a text translation model to be trained based on the sample text and the sample translation result to obtain the trained text translation model.

In summary, according to the apparatus for text translation in the embodiments of the present disclosure, the text to be translated may be input in the trained text translation model, a translation result of the current semantic unit may be generated based on the local context semantic units and the global context semantic units, which can solve the problem of incoherent translation and inconsistent translation of the context in the related art, improve the accuracy of the translation result, and be suitable for text translation scenario.

According to the embodiments of the present disclosure, the present disclosure also provides an electronic device, a readable-storage medium and a computer program product.

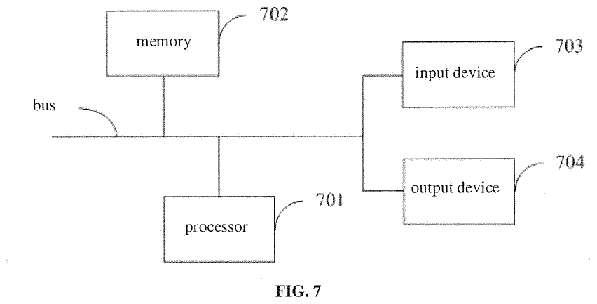

FIG. 7 is a block diagram illustrating an electronic device of a method for text translation according to an exemplary embodiment. Electronic devices are intended to represent various forms of digital computers, such as laptop computers, desktop computers, work tables, personal digital assistants, servers, blade servers, mainframe computers, and other suitable computers. Electronic devices can also represent various forms of mobile apparatus, such as smart voice interaction devices, personal digital processors, cellular phones, smart phones, wearable devices, and other similar computing apparatus. The components illustrated herein, their connections and relationships, and their functions are merely exemplary, and are not intended to limit the implementation of the disclosure described and/or required herein.

As illustrated in FIG. 7, the electronic device includes one or more processors 701, a memory 702, and interfaces for connecting various components, including high-speed interfaces and low-speed interfaces. The various components are connected to each other via different buses, and may be installed on a common motherboard or installed in other ways as required. The processor 701 may process instructions executed in the electronic device, including instructions stored in or on the memory to display graphical information of a graphic user interface (GUI) on an external input/output device (such as a display device coupled to an interface). In other embodiments, when necessary, a plurality of processors and/or a plurality of buses may be used with a plurality of memories and a plurality of memories. Similarly, a plurality of electronic devices may be connected, and each device provides some necessary operations (for example, as a server array, a group of blade servers, or a multi-processor system). In FIG. 7, a processor 701 is taken as an example.

The memory 702 is a non-transitory computer-readable storage medium according to the disclosure. The memory stores instructions that may be implemented by at least one processor, so that at least one processor implements the method for text translation according to the present disclosure. The non-transitory computer-readable storage medium of the present disclosure has computer instructions stored thereon, in which the computer instructions are used to cause a computer to implement the method for text translation according to the present disclosure.

As a non-transitory computer-readable storage medium, the memory 702 may be used to store non-transitory software programs, non-transitory computer-executable programs and modules, such as program instructions/modules corresponding to the method for text translation in the embodiments of the present disclosure (for example, the obtaining module 501, and the input module 502 illustrated in FIG. 5). The processor 701 implements various functional applications and data processing of the server, that is, implements the method for text translation in the above method embodiments, by running the non-transitory software programs, instructions, and modules stored in the memory 702.

The memory 702 may include a storage program area and a storage data area, in which the storage program area may store an operating system and at least an application program required by one function; the storage data area may store the data created by the use of the electronic device of the method for text translation. In addition, the memory 702 may include a high-speed random access memory, and may also include a non-transitory memory, such as at least one magnetic disk storage device, a flash memory device, or other non-transitory solid-state storage devices. In some embodiments, the memory 702 may optionally include a memory remotely provided relative to the processor 701, and these remote memories may be connected to the electronic device of the method for text translation. Examples of the above networks include, but are not limited to, the Internet, a corporate Intranet, a local area network, a mobile communication network, and combinations thereof.

The electronic device of the method for text translation may further include: an input device 703 and an output device 704. The processor 701, the memory 702, the input device 703, and the output device 704 may be connected via a bus or other methods. In FIG. 7, the connection by a bus is taken as an example.

The input device 703 may receive input numeric or character information, and generate key signal input related to the user settings and function control of the electronic device for the method for text translation, such as touch screens, keypads, mouses, trackpads, touchpads, and pointing sticks, one or more mouse buttons, trackballs, joysticks and other input devices. The output device 704 may include a display device, an auxiliary lighting device (for example, LED), a tactile feedback device (for example, a vibration motor), and the like. The display device may include, but is not limited to, a liquid crystal display (LCD), a light emitting diode (LED) display, and a plasma display. In some embodiments, the display device may be a touch screen.

Various implementations of the systems and technologies described herein may be implemented in digital electronic circuit systems, integrated circuit systems, specific application-specific integrated circuit (ASIC), computer hardware, firmware, software, and/or combinations thereof. These various implementation methods may be implemented in one or more computer programs, in which the one or more computer programs may be executed and/or interpreted on a programmable system including at least one programmable processor. The programmable processor may be a dedicated or general purpose programmable processor that may receive data and instructions from the storage system, at least one input device, and at least one output device, and transmit the data and instructions to the storage system, at least one input device, and at least one output device.

These computational procedures (also called programs, software, software applications, or codes) include machine instructions of a programmable processor, and may be implemented using high-level procedures and/or object-oriented programming languages, and/or assembly/machine language to implement computational procedures. As used herein, the terms “machine-readable medium” and “computer-readable medium” refer to any computer program product, device, and/or apparatus used to provide machine instructions and/or data to a programmable processor (for example, magnetic disks, optical disks, memories, programmable logic devices (PLDs)), including machine-readable media that receive machine instructions as machine-readable signals. The term “machine-readable signal” refers to any signal used to provide machine instructions and/or data to a programmable processor.

In order to provide interaction with the user, the systems and technologies described herein may be implemented on a computer and the computer includes a display apparatus for displaying information to the user (for example, a CRT (cathode ray tube) or an LCD (liquid crystal display) monitor)); and a keyboard and a pointing apparatus (for example, a mouse or a trackball) through which the user can provide input to the computer. Other types of apparatus can also be used to provide interaction with the user; for example, the feedback provided to the user may be any form of sensory feedback (for example, visual feedback, auditory feedback, or tactile feedback); and may be in any form (including acoustic input, voice input, or tactile input) to receive input from the user.

The systems and technologies described herein may be implemented in a computing system that includes back-end components (for example, as a data server), or a computing system that includes middleware components (for example, an application server), or a computing system that includes front-end components (for example, a user computer with a graphical user interface or web browser through which the user can interact with the implementation of the systems and technologies described herein), or a computing system that includes any combination of the back-end components, middleware components, or front-end components. The components of the system may be connected to each other through any form or medium of digital data communication (for example, a communication network). Examples of communication networks include: local area networks (LAN), wide area networks (WAN), and the Internet.

The computer system may include a client and a server. The client and server are generally far away from each other and usually interact through a communication network. The relationship between the client and the server is generated by computer programs that run on the corresponding computer and have a client-server relationship with each other. The server may be a cloud server, also known as a cloud computing server or a cloud host, which is a host product in the cloud computing service system to solve the problem of difficult management and weak business scalability of traditional physical hosts and VPS (Virtual Private Server, or in short, VPS) services. The server can also be a server for distributed system, or a server that combine block chain.

According to the embodiments of the present disclosure, there is also provided a computer program product including computer programs, in which when the computer programs are executed by a processor, the processor is caused to implement the method for text translation described in the embodiments of the present disclosure.

According to the technical solution of the embodiments of the present disclosure, the text to be translated may be input in the trained text translation model, and a translation result of the current semantic unit may be generated based on the local context semantic units and the global context semantic units, which can solve the problem of incoherent translation and inconsistent translation of the context in the related art, improve the accuracy of the translation result, and be suitable for text translation scenario.

It should be understood that the various forms of processes illustrated above may be used to reorder, add or delete actions. For example, the actions described in the present disclosure may be executed in parallel, sequentially, or in a different order, as long as the desired result of the technical solution disclosed in the present disclosure may be achieved, this is not limited herein.

The above specific implementations do not constitute a limitation on the protection scope of the present disclosure. Those skilled in the art should understand that various modifications, combinations, sub-combinations and substitutions may be made based on design requirements and other factors. Any modification, equivalent replacement and improvement made within the spirit and principle of the disclosure shall be included in the protection scope of this disclosure.

What is claimed is:

1. A method for text translation, comprising:
obtaining a text to be translated; and
inputting the text to be translated into a trained text translation model,
wherein the trained text translation model is configured to perform:
dividing the text to be translated into a plurality of semantic units,
determining N semantic units before a current semantic unit among the plurality of semantic units as local context semantic units, wherein N is an integer,
determining M semantic units before the local context semantic units as global context semantic units, wherein M is an integer, and
generating a translation result of the current semantic unit based on the local context semantic units and the global context semantic units.

2. The method of claim 1, wherein generating the translation result of the current semantic unit comprises:
generating a vector representation of the current semantic unit based on vector representations of the global context semantic units;
generating a local translation result corresponding to the current semantic unit and the local context semantic units based on the vector representation of the current semantic unit and vectors representation of the local context semantic units; and
generating the translation result of the current semantic unit based on the local translation result and a translation result of the local context semantic units.

3. The method of claim 2, wherein generating the vector representation of the current semantic unit comprises:
dividing the current semantic unit into at least one word segmentation;
generating a global fusion vector representation of each word segmentation based on a vector representation of each word segmentation and the vector representations of the global context semantic units; and
generating the vector representation of the current semantic unit based on the global fusion vector representation of each word segmentation.

4. The method of claim 3, wherein generating the global fusion vector representation of each word segmentation comprises:
performing linear transformation on the vector representation of each word segmentation to generate a semantic unit vector representation of each word segmentation at a semantic unit level;
performing feature extraction on the vector representations of the global context semantic units based on the semantic unit vector representation of each word segmentation to generate a global feature vector; and
fusing the global feature vector and the vector representation of the word segmentation to generate the global fusion vector representation of each word segmentation.

5. The method of claim 3, wherein generating the vector representation of the current semantic unit based on the global fusion vector representation of each word segmentation comprises:
determining each weight corresponding to the global fusion vector representation of each word segmentation; and
calculating the vector representation of the current semantic unit based on the global fusion vector representation of each word segmentation and each weight.

6. The method of claim 1, further comprising:
obtaining a sample text and a sample translation result corresponding to the sample text; and
training a text translation model to be trained based on the sample text and the sample translation result, to obtain the trained text translation model.

7. An apparatus for text translation, comprising:
at least a processor; and
a memory communicatively coupled to the at least one processor and stored with instructions executable by the at least one processor;
wherein the at least one processor is configured to:
obtain a text to be translated; and
input the text to be translated into a trained text translation model, wherein the trained text translation model is configured to perform:
dividing the text to be translated into a plurality of semantic units,
determining N semantic units before a current semantic unit among the plurality of semantic units as local context semantic units, wherein N is an integer,
determining M semantic units before the local context semantic units as global context semantic units, wherein M is an integer and
generating a translation result of the current semantic unit based on the local context semantic units and the global context semantic units.

8. The apparatus of claim 7, wherein the at least one processor is further configured to:
generate a vector representation of the current semantic unit based on vector representations of the global context semantic units;
generate a local translation result corresponding to the current semantic unit and the local context semantic units based on the vector representation of the current semantic unit and vector representations of the local context semantic units; and
generate the translation result of the current semantic unit based on the local translation result and a translation result of the local context semantic units.

9. The apparatus of claim 8, wherein the at least one processor is further configured to:
divide the current semantic unit into at least one word segmentation;
generate a global fusion vector representation of each word segmentation based on a vector representation of each word segmentation and the vector representations of the global context semantic units; and
generate the vector representation of the current semantic unit based on the global fusion vector representation of each word segmentation.

10. The apparatus of claim 9, wherein the at least one processor is further configured to:
perform linear transformation on the vector representation of each word segmentation to generate a semantic unit vector representation of each word segmentation at a semantic unit level;
perform feature extraction on the vector representations of the global context semantic units based on the semantic unit vector representation of each word segmentation to generate a global feature vector; and
fuse the global feature vector and the vector representation of each word segmentation to generate the global fusion vector representation of each word segmentation.

11. The apparatus of claim 9, wherein the at least one processor is further configured to:
determine each weight corresponding to the global fusion vector representation of each word segmentation; and
calculate the vector representation of the current semantic unit based on the global fusion vector representation of each word segmentation and each weight.

12. The apparatus of claim 7, wherein the at least one processor is further configured to:
obtain a sample text and a sample translation result corresponding to the sample text; and
train a text translation model to be trained based on the sample text and the sample translation result to obtain the trained text translation model.

13. A non-transitory computer-readable storage medium having computer instructions stored thereon, wherein the computer instructions are configured to cause a computer to implement a method for text translation, the method comprising:
obtaining a text to be translated; and
inputting the text to be translated into a trained text translation model,
wherein the trained text translation model is configured to perform:
dividing the text to be translated into a plurality of semantic units,
determining N semantic units before a current semantic unit among the plurality of semantic units as local context semantic units, wherein N is an integer,
determining M semantic units before the local context semantic units as global context semantic units, wherein M is an integer, and
generating a translation result of the current semantic unit based on the local context semantic units and the global context semantic units.

14. The storage medium of claim 13, wherein generating the translation result of the current semantic unit comprises:
generating a vector representation of the current semantic unit based on vector representations of the global context semantic units;
generating a local translation result corresponding to the current semantic unit and the local context semantic units based on the vector representation of the current semantic unit and vectors representation of the local context semantic units; and
generating the translation result of the current semantic unit based on the local translation result and a translation result of the local context semantic units.

15. The storage medium of claim 14, wherein generating the vector representation of the current semantic unit comprises:
dividing the current semantic unit into at least one word segmentation;
generating a global fusion vector representation of each word segmentation based on a vector representation of each word segmentation and the vector representations of the global context semantic units; and
generating the vector representation of the current semantic unit based on the global fusion vector representation of each word segmentation.

16. The storage medium of claim 15, wherein generating the global fusion vector representation of each word segmentation comprises:
performing linear transformation on the vector representation of each word segmentation to generate a semantic unit vector representation of each word segmentation at a semantic unit level;
performing feature extraction on the vector representations of the global context semantic units based on the semantic unit vector representation of each word segmentation to generate a global feature vector; and
fusing the global feature vector and the vector representation of the word segmentation to generate the global fusion vector representation of each word segmentation.

17. The storage medium of claim 15, wherein generating the vector representation of the current semantic unit based on the global fusion vector representation of each word segmentation comprises:
determining each weight corresponding to the global fusion vector representation of each word segmentation; and
calculating the vector representation of the current semantic unit based on the global fusion vector representation of each word segmentation and each weight.

18. The storage medium of claim 13, wherein the method further comprises:
obtaining a sample text and a sample translation result corresponding to the sample text; and
training a text translation model to be trained based on the sample text and the sample translation result, to obtain the trained text translation model.
